(19) United States
(12) Patent Application Publication
(10) Pub. No.: US 2003/0194691 A1
(43) Pub. Date: Oct. 16, 2003

(54) Sensory feedback educational tool

(76) Inventor: Donna James, York, PA (US)

Correspondence Address: Jeffrey S. Habib, Esq., Thomas Hooker, P.C., Suite 304, 100 Chestnut Street, Harrisburg, PA, 17101, US

(21) Appl. No.: 10/121,797

(22) Filed: Apr. 15, 2002

(51) Int. Cl. B43L 1/00

(52) U.S. Cl. 434/408

(57) ABSTRACT

An educational tool for teaching a child to read and write includes a writing board having a writing surface. A raised rim extends around the writing surface, the rim and the writing surface defining the interior of the tool for holding a displaceable writing medium. Indicia are disposed about the writing surface. The indicia provide additional sensory feedback to the child that assists the child in learning.

### FIELD OF THE INVENTION

The invention relates to an educational tool for teaching reading and writing skills.

### BACKGROUND OF THE INVENTION

A known educational tool for teaching reading and writing skills includes a flat writing surface and a raised rim that surrounds the surface. A displaceable writing medium, commonly table salt, is distributed over the writing surface. The child writes in the salt by pressing his or her finger against the surface and forming letters, numbers or shapes. Shaking re-distributes the salt and erases the writing. The rim prevents the salt from spilling from the writing surface.

The tool assists young or physically challenged children in learning to read and write. Many such children lack the muscle coordination to hold chalk or pencils. The tool enables a child to write with just his or her finger, without use of chalk or pencils. The child receives visual and tactile feedback while writing in the salt, and many students find the tool fun and motivating to use.

### SUMMARY OF THE INVENTION

The invention is an improved educational tool for teaching reading and writing skills.

An educational tool in accordance with the present invention includes a writing board having a writing surface. A raised rim extends around the writing surface, the rim and the writing surface defining the interior of the tool for holding a displaceable writing medium. Indicia are disposed about the writing surface. The indicia provide additional sensory feedback to the child that assists the child in learning to read and write.

In preferred embodiments the indicia includes letters, numerals or shapes that correspond to letters, numerals or shapes written or read by the child in the writing medium. The indicia provide additional visual feedback that enables the child to see correctly formed letters, numerals or shapes before, during and after writing in the writing medium.

The indicia can be located on the rim and/or on an outer periphery of the writing board. The indicia can be even with the rim or periphery surface. In alternative embodiments the indicia can have raised or recessed surfaces that provide tactile feedback to a child running his or her fingers over the indicia and feeling the shape of the indicia by its edges.

In particularly preferred embodiments of the present invention the writing surface is a non-stick or low friction surface. The surface resists sticking and reduces finger drag while writing.

In yet other embodiments of the present invention the tool includes a pour spout extending from the interior of the tool to outside the tool for convenient removal of writing medium.

Other objects and features of the invention will become apparent as the description proceeds, especially when taken in conjunction with the accompanying four drawing sheets illustrating five embodiments of the invention.

### BRIEF DESCRIPTION OF THE DRAWINGS

FIG. 1 is a top view of a first embodiment educational tool made in accordance with the present invention;

FIG. 2 is a perspective view of a child writing in the tool shown in FIG. 1;

FIG. 3 is a top view of a second embodiment educational tool made in accordance with the present invention;

FIG. 4 is a sectional side view of the educational tool shown in FIG. 3;

FIG. 5 is a top view of a third embodiment educational tool made in accordance with the present invention;

FIG. 6 is a partial side view of a portion of a fourth embodiment educational tool similar to the tool shown in FIG. 5 but including raised indicia; and

FIG. 7 is a partial side view of a portion of a fifth embodiment educational tool similar to the tool shown in FIG. 5 but including recessed indicia.

### DESCRIPTION OF THE PREFERRED EMBODIMENTS

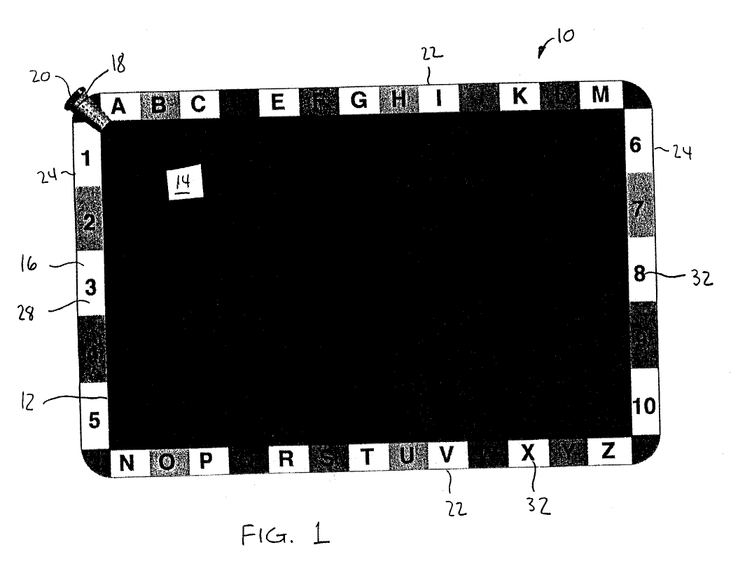

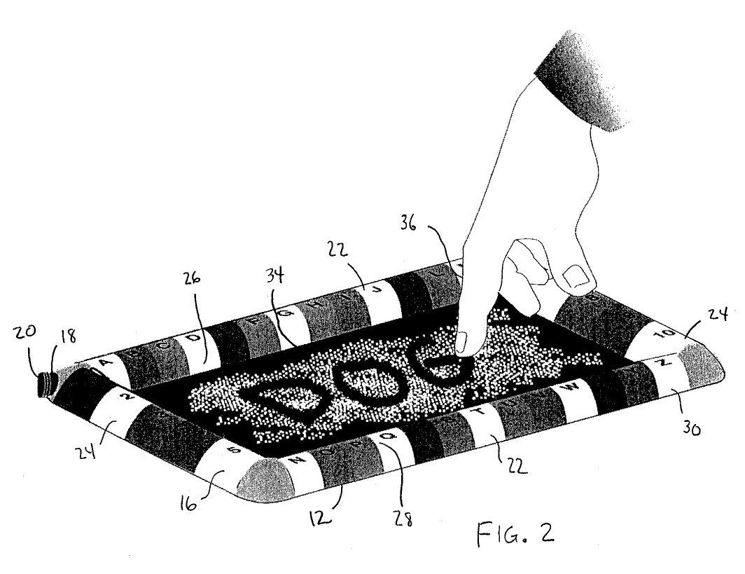

FIGS. 1 and 2 illustrate a first embodiment educational tool 10 in accordance with the present invention. The educational tool 10 includes a writing board 12 that defines an upwardly facing, generally flat writing surface 14. A raised rim 16 extends upwardly from the writing board 12 around the outer perimeter of the writing surface. The rim and writing surface defines the interior of the tool 10.

A pour spout 18 extends from the interior of the tool, through the rim 16, to the outside of the tool. For clarity the portion of the rim above the spout is not shown in FIG. 1 so that the entire length of spout would be shown in the drawing. The spout includes a removable spout plug 20 that closes the outer end of the pour spout. The plug is preferably attached to or hinged to the outer end of the spout.

Rim 16 includes a pair of opposed longer sides 22 and a pair of opposed shorter sides 24. Each side has a similar convex cross section, with a generally vertical inner face 26, an upper face 28 facing away from the writing surface and an outer face 30.

Formed on the upper face 28 are a number of spaced apart indicia 32. The indicia 32 in the illustrated embodiment include letters of the alphabet extending along the longer sides of the rim and numerals extending along the shorter sides of the rim, the letters or numerals printed within contrasting color bands spaced along the rim. It should be understood that other indicia can be used as desired.

FIG. 2 illustrates use of the tool 10. A conventional displaceable writing medium 34, preferably table salt, is poured on the writing surface 14. Other suitable writing media include sand, rice, and viscous fluids such as cornstarch and water mixtures. The writing surface is preferably finished in a contrasting color from the writing medium so that writing formed in the medium is clearly visible against the surface. In the illustrated embodiment the surface 14 is colored black to provide high contrast against the white table salt.

The figure illustrates a child writing in the salt with his or her finger 36. The child's finger pressing against the surface 14 and displacing the salt 34 provides tactile feedback to the child while writing. The high-contrast, easily visible writing formed in the salt provides visual feedback to the child that accompanies the tactile feedback.

In addition, the indicia 36 provide additional visual feedback that assists the child in learning to read and write. For example, as shown in FIG. 2, the child is writing the word DOG. The indicia 36 includes the letters D, O, G that enable the child to see the correct shape of the letters. The child can use the indicia 36 before, during and after writing in the tool 10 for assistance in learning to read and write with the tool 10.

After use, the plug 20 is removed from the spout 18 and the salt is poured out of the tool through the spout 18 for easy cleanup.

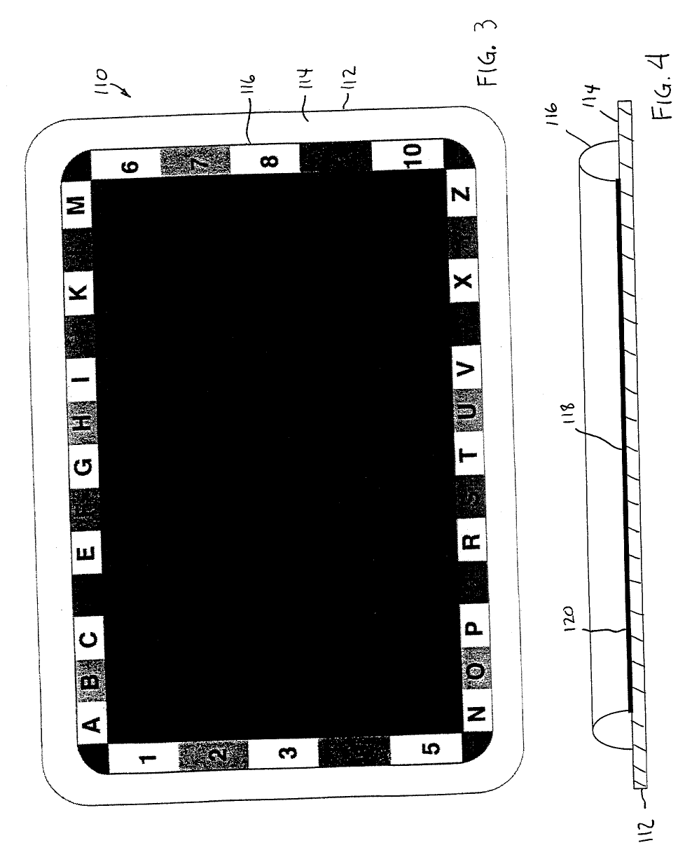

FIGS. 3 and 4 illustrate a second embodiment educational tool 110 similar to educational tool 10. The writing board 112 includes an outer periphery 114 that extends beyond the rim 116. The extended outer periphery provides additional stability for the tool 110. In this embodiment the writing surface 118 includes a non-stick or low friction coating 120 that reduces finger drag when writing. The coating can be made from TEFLON (trademark) low friction material or functional equivalent.

FIG. 5 illustrates a third embodiment educational tool 210 similar to educational tool 110. The upper surface of the outer periphery 212 includes additional indicia 214 (not all are shown in FIG. 5). The additional indicia 214 include simple spelled-out words, outlines or drawings of objects spelled out by the words, and common geometric shapes. For example, the indicia shown in FIG. 5 includes the word DOG and a representation of a dog that would be helpful to a child attempting to read or write the word DOG formed in the salt with the tool 210.

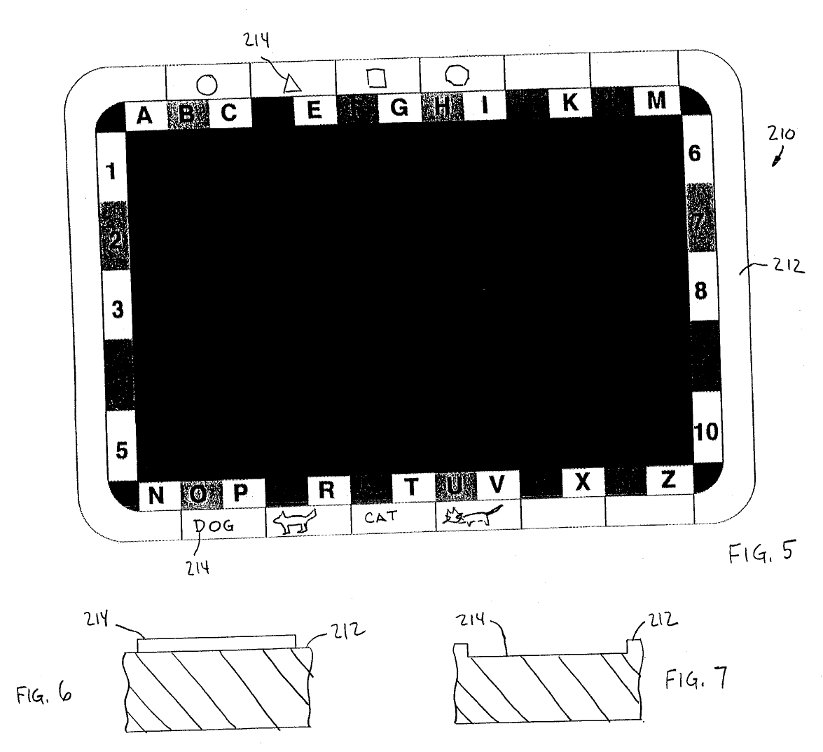

The indicia 214 can be formed substantially even with the upper surface of periphery 212. Alternatively, as shown in FIGS. 6 and 7, the indicia 214 can extend above or be proud of the surface (FIG. 6) or be recessed below the surface (FIG. 7). Such indicia can provide tactile feedback to a child running his or her fingers over the indicia and feeling the shape of the indicia by its edges.

While I have illustrated and described a preferred embodiment of my invention, it is understood that this is capable of modification, and I therefore do not wish to be limited to the precise details set forth, but desire to avail myself of such changes and alterations as fall within the purview of the following claims.

What I claim as my invention is:

1. An educational tool for providing visual and tactile feedback to a student learning reading and writing skills comprising:
a writing board comprising a writing surface;
a raised rim extending around the writing surface, the rim and the writing surface defining the interior of the tool for holding a displaceable writing medium; and
indicia disposed about the writing surface to provide additional sensory feedback to the student while using the tool.

2. The educational tool according to claim 1 wherein the rim comprises a surface spaced away from the writing surface and the indicia is disposed on the rim surface.

3. The educational tool according to claim 2 wherein the rim surface faces away from the writing surface.

4. The educational tool according to claim 1 wherein the rim is located between the writing surface and the indicia.

5. The educational tool according to claim 4 wherein the writing board comprises an outer periphery extending outwardly beyond the rim and the indicia are on such outer periphery.

6. The educational tool according to claim 1 wherein the indicia comprises one of: a letter, a number, a geometrical shape and a representation of a physical object.

7. The educational tool according to claim 1 comprising a pour spout for flowing writing medium out of the interior of the tool, the pour spout communicating the interior of the tool with the exterior of the tool for flowing writing medium out of the tool.

8. The educational tool according to claim 1 wherein the writing surface comprises a low friction surface.

9. The educational tool according to claim 1 wherein the indicia comprise raised or recessed indicia.

10. An educational device for providing visual and tactile feedback to students learning reading and writing skills comprising:
a writing board comprising a writing surface;
a raised rim extending around the writing surface, the rim and the writing surface defining the interior of the device for holding a displaceable writing medium in the device; and
a pour spout for flowing writing medium out of the interior of the device, the pour spout communicating the interior of the device with the exterior of the device.

11. The educational device of claim 10 wherein the pour spout extends through the rim.

12. The educational device of claim 10 wherein the pour spout includes a removable member for closing an end of the spout.

13. The educational device of claim 10 wherein the writing surface comprises a low-friction surface.
